(19) United States
(12) Patent Application Publication
(10) Pub. No.: US 2005/0278298 A1
(43) Pub. Date: Dec. 15, 2005

(54) Systems and methods for organizing and displaying data

(76) Inventor: Kenneth Slenkovich, Delaware, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/152,597

(22) Filed: Jun. 14, 2005

Related U.S. Application Data
(60) Provisional application No. 60/579,298, filed on Jun. 14, 2004.

(51) Int. Cl. G06F 7/00

(52) U.S. Cl. 707/1

(57) ABSTRACT

Example systems, software, methods, computer-readable media, and so on, associated with organization of data or links to data are provided. In one embodiment, a system includes an organization logic configured to establish relationship data for a plurality of data files, and a display logic configured to visually represent an organization of information using the relationship data.

### CROSS REFERENCE TO RELATED APPLICATION

This application claims priority to U.S. Provisional application No. 60/579,298, filed on Jun. 14, 2004, the disclosure of which is incorporated herein in its entirety.

### BACKGROUND

Computer systems, networks, and so on, can store large amounts of information that may typically be distributed between many data files on one or more storage devices. Keeping track of and organizing the data files becomes problematic, especially for users that may not be familiar with the storage devices or their navigation techniques. Additionally, a user may have difficulties in associating related files, for example when the files are stored in different locations, and in navigating through the locations to identify, retrieve, or take other actions with related files.

### BRIEF DESCRIPTION OF THE DRAWINGS

In the accompanying drawings, which are incorporated in and constitute a part of the specification, embodiments are illustrated which, together with the detailed description given below, serve to describe the example embodiments. It will be appreciated that the embodiments illustrated in the drawings are shown for the purpose of illustration and not for limitation. It will be appreciated that the figures may not be drawn to scale and that selected components within any figure may be illustrated in enlarged or reduced form without comment to improve clarity and understanding of particular concepts being discussed. Any shading used in the figures is to improve clarity of elements or components for discussion. Shading is not intended to suggest any particular characteristics or attributes. It will be appreciated that changes, modifications and deviations from the embodiments illustrated in the drawings may be made without departing from the spirit and scope of the invention, as disclosed below. It will be appreciated that illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa.

FIG. 1 illustrates an example system 100 for organizing and/or displaying data and/or data files;

FIG. 2 illustrates an example visual representation of an organization of information;

FIG. 3 illustrates another example visual representation of an organization of information;

FIG. 4 illustrates another example visual representation of an organization of information;

FIG. 5 illustrates contents of an example data file;

FIG. 6 illustrates another example visual representation of an organization of information;

FIG. 7 illustrates another example visual representation of an organization of information;

FIG. 8 illustrates another example visual representation of an organization of information;

FIG. 9 illustrates another example visual representation of an organization of information;

FIG. 10 illustrates an example method 1000 for organizing and/or displaying data; and

FIG. 11 illustrates an example computer 1100 including an organization logic 1125 and a display logic 1130.

### DETAILED DESCRIPTION

The following includes definitions of selected terms that may be used throughout the disclosure. The definitions include examples of various embodiments and/or forms of components that fall within the scope of a term and that may be used for implementation. The examples are not intended to be limiting and other embodiments may be implemented. Both singular and plural forms of all terms fall within each meaning.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication”, as used herein, refers to a communication between two or more computing devices (e.g., computer, personal digital assistant, cellular telephone) and can be, for example, a network transfer, a file transfer, an applet transfer, an e-mail message, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory, and so on. Transmission media may include coaxial cables, copper wire, fiber optic cables, and so on. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, and so on. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Query”, as used herein, refers to a semantic construction that facilitates gathering and processing information. A query might be formulated in a database query language like structured query language (SQL) or object query language (OQL). A query might be implemented in computer code (e.g., C#, C++, Javascript) that can be employed to gather information from various data stores and/or information sources.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer, and so on. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow may be presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantifies. Usually, though not necessarily, the physical quantities take the form of electrical or magnetic signals capable of being stored, transferred, combined, compared, and otherwise manipulated in a logic and so on.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, and so on, refer to actions and processes of a computer system, logic, processor, or similar electronic device that manipulates and transforms data represented as physical (electronic) quantities.

This application describes example systems, organizations, software, methods, computer-readable media, and so on, associated with organization of data and/or links to data, and/or displaying data and/or links to data. In one example, the systems, and so on, may provide an organization logic and a display logic. The organization logic may be configured to examine computer data and/or data files, and establish relationship data for the data files. The organization logic may be configured to store the relationship data for the data files. The display logic may be configured to receive the relationship data from the organization logic, or use the relationship data, and to visually represent an organization of information relating to the data files by using the relationship data.

In one example, the systems, and so on, may provide an organization of links to data files. The organization of links may include a visual representation of at least one multi-dimensional object with dimensions of the object labeled with categories and the categories delimited by parameters. The organization of links may also include groupings of links, where each link facilitates retrieval of one or more data files. The position of a group of links within the multi-dimensional object may be described by a set of parameters, which may include one parameter from each category that labels a dimension of the object. Generally, the links to data files included within a group of links may facilitate retrieval of data files that are related. The relationships between related files may be embodied in the set of parameters used to describe the location within the object of the grouping of links to which the links belong.

The example systems, organizations, software, methods, computer-readable media, and so on, associated with organization of data and/or links to data, and/or displaying data and/or links to data, may be used for a variety of purposes. For example, the systems, and so on, may facilitate visualization, retrieval, analysis, presentation, management, project planning, relationship discovery, conceptualization, and so on, of, with or between selected data and/or data files. In one example, the disclosed systems, and so on, provide a visual project-based electronic filing cabinet or index for data and/or data files. In one example, the disclosed systems, and so on, provide a graphical interface that can be used by experienced or inexperienced computer users to access, navigate, and use data and/or data files.

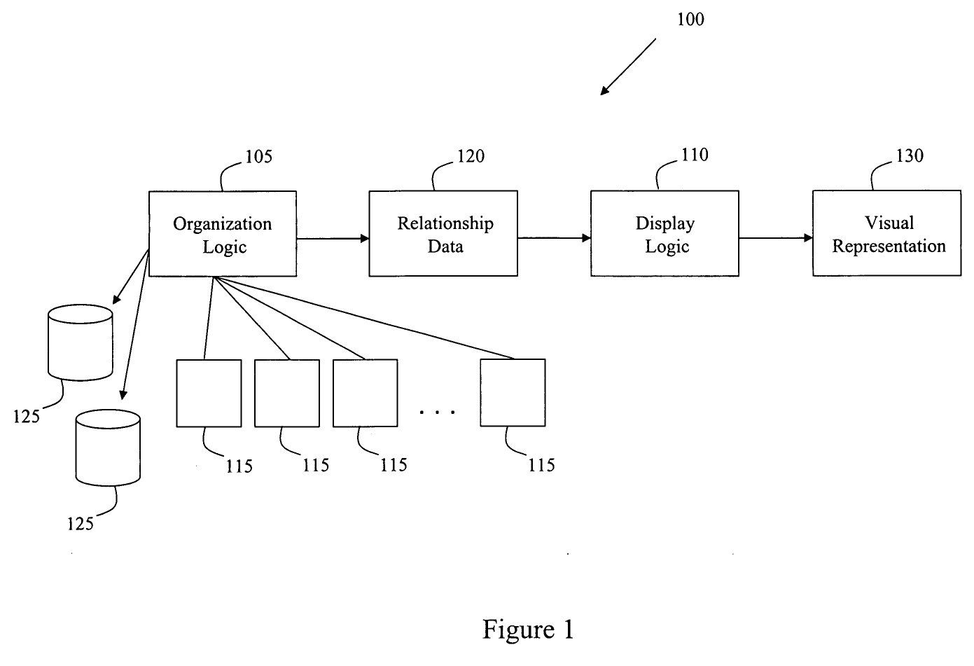

FIG. 1 illustrates an example system 100 for organizing and displaying data and/or data files. The example system 100 can include an organization logic 105 and a display logic 110. The organization logic 105 may be configured to examine a plurality of data files 115 to establish relationship data 120 between one or more of the plurality of data files 115. The data files 115 may be located in one or more locations on one or more storage devices 125. For example, the data files may be located on one or more computers, hard drives, computer networks, data stores, and so on. The organization logic 105 may be configured to store the relationship data 120.

Herein, “relationship data” 120, may refer to information concerning the relatedness or differences between data, files, and/or data files. For example, relationship data 120 may include data, parameters, categories, attributes, content, descriptions, locations, and so on, related to data files 115, that indicate or facilitate describing relationships or associations between the data files 115 or other objects. In one example, data files 115 that contain information pertaining to the same subject or aspects of a subject may be considered related and this information may be included in the relationship data 120. In another example, data files 115 that contain information related to solutions to a problem may be considered related and may be included in the relationship data 120. It will be appreciated that there are a variety of characteristics and/or criteria that can be used to determine whether data files are related.

Determining, producing or establishing relationship data 120 may involve, but is not restricted to, one or more of: searching for or querying files; comparing files, their content or characteristics; making decisions, establishing relationships, assigning parameters, and so on, based on the searching and comparing; arranging and/or indexing files; and so on. In one example, one or more of these actions can be performed manually by a user. The relationship data 120 may be input into the organization logic 105 and may be stored therein. In another embodiment, the relationship data 120 can be determined by logic (e.g., organization logic 105) embodied in one or more computer components, computer-readable media, software, and so on. The logic can be configured to generate and/or store the relationship data 120.

In one example of producing relationship data 120, data files 115 may be related, or relationships between data files 115 may be generated, based on selected criteria. The criteria may be selected by a user. For example, suppose it is desired to organize data files 115 related to a project called “XYZ”. Selected storage devices can be searched and data files 115 related or possibly related to the XYZ project can be identified. Data files 115 relating to particular aspects of project XYZ may be noted and included in the relationship data 120.

In one example, data files 115 may be related, or relationships between data files 115 may be generated, based on criteria not selected by a user. In one example, a logic (e.g., organization logic 105) may be capable of establishing relationships between data files without or with minimal input from a user.

With further reference to FIG. 1, the display logic 110 may be configured to produce a visual representation 130 of an organization of information concerning the plurality of data files 115. Production of the visual representation 130 by the display logic 110 generally may involve using the relationship data 120. In one example, the relationships between files may be included or represented in the visual representation 130 and may be visually presented to a user, as in a computer display for example. The visual representation 130 of the organization of information may involve displaying the names, subject matter, location, and so on, of related data files 115. Displaying the names, and so on, of the data files 115 may take the form of displaying hyperlinks or links to, or associated with, the data files 115. The displayed links may facilitate or enable retrieval of the data files 115 to which an individual link is associated. Display of the names, links, and so on, of or associated with data files 115 may be organized into groups, proximal groupings, and so on, within the visual representation 130. The data files 115 represented in a group generally are data files 115 that are related in some way. Generally, retrieval of the data files 115, by a user for example, is facilitated or optimized by the organization or grouping of their names, links, and so on, within the visual representation 130.

In one example, a visual representation 130 of an organization of information concerning data files 115 may include a visual display of at least one multi-dimensional object that acts as a framework or reference for placement of links or groups of links to data files 115. Each dimension of the multi-dimensional object may be labeled by a data category or category. Each category may be delimited or delineated by discrete data parameters or parameters. When the multi-dimensional object is labeled and delimited in this way, a “set” of parameters, that includes a parameter from each category, describes a specific location within the multi-dimensional object. A grouping of links may be placed at these specific locations.

In one example, a multi-dimensional object may be divided into smaller objects. The smaller objects may be visually represented as multi-dimensional and, as such, may include surfaces (e.g., a cube may have 6 surfaces as well as an area interior to the cube). Links or groups of links to data files 115 may be associated with the smaller objects. For example, links may be associated with one or more of the surfaces and/or interior of the smaller objects.

The visual representation 130 can be configured to be interactive. In one example, the visual representation 130 may display a subset or subsets of the total set of smaller objects or links that exist in the system. A user may select, designate, input, specify, and so on, one or more categories and/or parameters to display the subset or subsets. Display of the subset/subsets of smaller objects and/or links may facilitate identification, retrieval, and so on, of one or more data files 115.

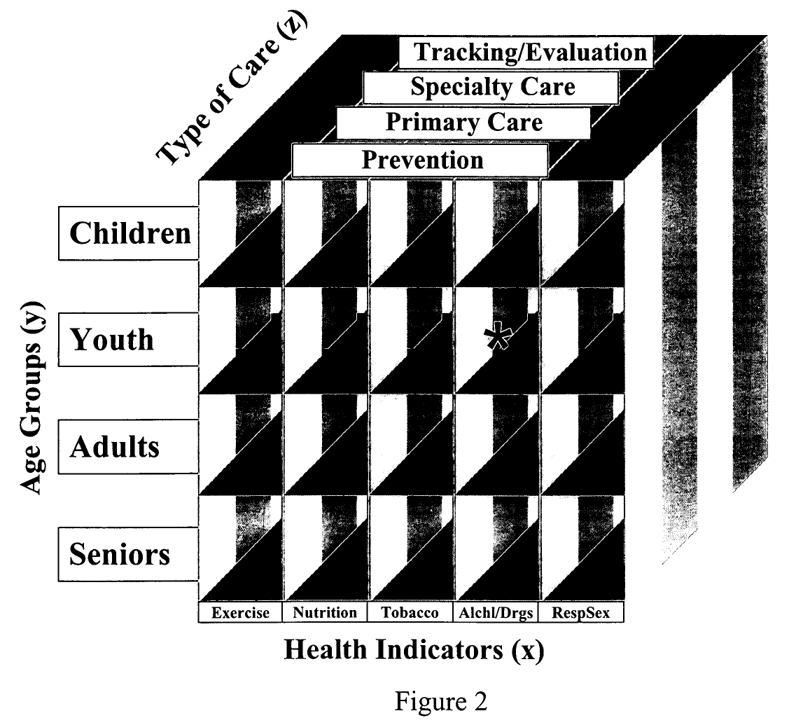

FIG. 2 illustrates an example visual representation of an organization of information. In this example, a three-dimensional image of a geometric shape or object, here a cube, is shown. Other shapes can be used. Shapes other than three-dimensional shapes can be used. The example three-dimensional object is used to organize links to data files, as is shown in later figures. The dimensions of the cube are defined by x, y and z axes. In the illustration, the x-axis is called “health indicators,” the y-axis is called “age groups,” and the z-axis is called “type of care.” Health indicators, age groups and type of care may be called data categories or categories, and these may be used to label the dimensions of the multi-dimensional object, in this case a cube.

In the example shown in FIG. 2, the categories are delimited or delineated by discrete data parameters, discrete parameters, or parameters. In this example, the category “health indicators,” that labels the x-axis of the cube, is delineated by the parameters, “exercise,” “nutrition,” “tobacco,” “alcohol/drugs,” and “responsible sex.” The category “age groups,” that labels the y-axis of the cube, is delineated by the parameters, “seniors,” “adults,” “youth,” and “children.” The category “type of care,” that labels the z-axis of the cube is delineated by the parameters, “prevention,” “primary care,” “specialty care,” and “tracking/evaluation.” It will be appreciated that a “set” of parameters, that includes a parameter from each category, identifies or describes a particular location within the cube.

In the example shown in FIG. 2, the multi-dimensional cube may be divided into smaller objects. In this example, the smaller objects are also cubes. Each smaller cube may occupy a discrete set of parameters within the larger cube. In the particular example illustrated in FIG. 2, there are 80 of the smaller cubes, which may be calculated by multiplying together the number of parameters in each category (5 in health indicators, 4 in age groups, 4 in type of care). The location of each cube, therefore, can be described by stating a parameter from the “health indictors” category, a parameter from the “age groups” category, and a parameter from the “type of care” category. In the illustrated example, the smaller cube defined by the set of data parameters “alcohol/drugs” (x-axis), “youth,” (y-axis), and “prevention” (z-axis), based on the x, y and z axes respectively, locates the cube that is designated by the asterisk (“*”) in FIG. 2.

The multi-dimensional cube, or other object, that has its dimensions labeled by categories, may be referred to as a “top-level” object or image. The smaller cubes, that have locations described by sets of data parameters, may be referred to as “intermediate-level” objects or images. Intermediate-level objects may contain still-smaller objects (not shown). The still-smaller objects may be divided into still-smaller objects, and so on. An object may be called a “bottom-level” object if it does not contain smaller objects (e.g., if it does not lead to another, deeper level image). As will be described later, links to data files may be associated with objects at any level (e.g., top, intermediate, bottom). In the case where intermediate-level objects exist, the dimensions of the intermediate-level objects may be labeled by categories. These categories may be delineated by parameters. A set of these parameters may describe the location of bottom-level objects or other information that is/are contained within the intermediate-level object.

It will be appreciated that there may be multiple ways to organize top-, intermediate-, or bottom-level objects. Geometric shapes other than rectangles or cubes may be used. Also, a top-level image organized in one way may be readily organized or reorganized in another way. Axes may represent different categories, depending on the arrangement. A category may have different parameters, depending on the arrangement. This organization and/or reorganization feature may make use of the interactive nature of the system. The interactive nature of the system is described in more detail later.

It will also be appreciated that where there is, for example, a top-level image, a bottom-level image and one or more intermediate-level images, a visual representation of an image at any level may provide for navigating to a visual representation of an image at any other level. This feature is also generally related to the interactive nature of the system. For example, it may be possible for a user to move or toggle from a visual representation of a top-level image directly to a visual representation of a bottom-level image without toggling through intermediate-level images. One example system may provide for a user to navigate between different levels of images by “clicking” within a visual representation of an image or otherwise designating that an image representing a particular level is to be displayed.

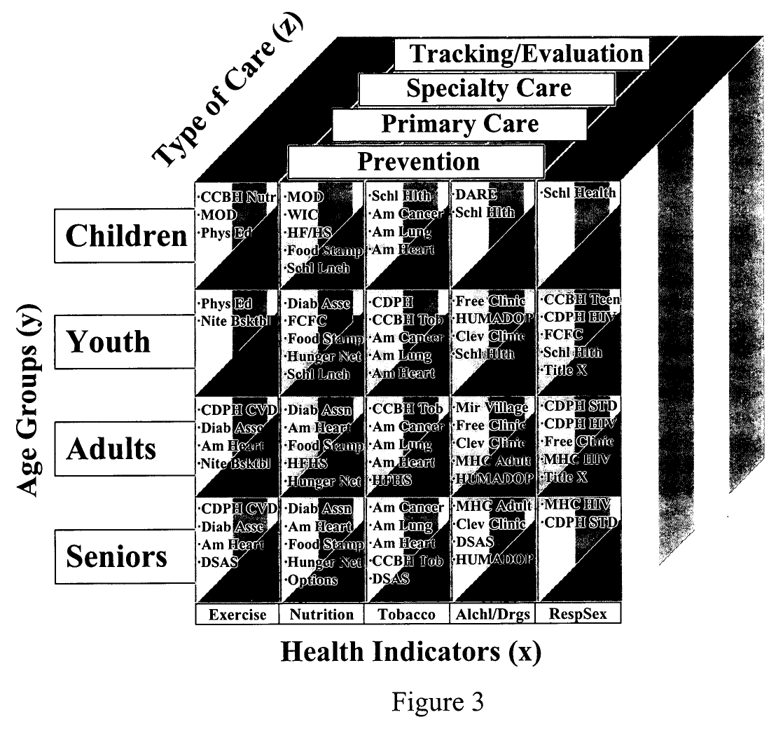

FIG. 3 illustrates another example visual representation of an organization of information. This illustration is similar to that shown in FIG. 2, except that lettering is visible in the smaller cubes that occupy the “prevention” parameter of the “type of care” category (z-axis). In this example, the lettering represents hyperlinks or links to data files. For example, in the smaller cube defined by the set of data parameters “alcohol/drugs” (x-axis), “youth,” (y-axis), and “prevention” (z-axis), the letterings “Free Clinic,” “HUMADOP,” “Cleve. Clinic,” and “School Health” each represent a link to a separate data file. In the illustration, the links appear to be associated with the front surface or face of the smaller cubes, or with the interior of the smaller cubes. It should be appreciated that links may be associated with any or all of the surfaces of the objects. This feature will be described in more detail later.

It will also be appreciated that there generally is a “descriptive” or “informative” relationship between a link (and the data file associated with a link) and the set of parameters used to describe the position of the link within an object. For example, the system that is illustrated in FIG. 3 generally was set up to organize and display data files related to community health in northeastern Ohio. In this particular example, the available data files were assigned one parameter from each of the “health indicators” (x-axis), “age groups,” (y-axis), and “type of care” (z-axis) categories, based on content of the files and the relationship of the content to these named discrete data parameters.

In one example, each of the links, “Free Clinic,” “HUMADOP,” “Cleve. Clinic,” and “School Health” (located at x, “alcohol/drugs”; y, “youth”; and z, “prevention” in FIG. 3) is associated with a data file whose contents are related to community health issues related to alcohol/drugs, youth, and prevention. For example, a data file associated with a link located in this smaller cube may have information related to agencies that provide preventive anti-alcohol and/or anti-drug education for youths. In another example, a data file associated with a link located in this smaller cube may have information related to a research study examining the types of programs that are effective in preventing drug use by youths. Many other examples could be given. One of skill in the art will also appreciate that a specific data file may be associated with links that have more than one location within an object (e.g., links to the same data file may be located in positions described by more than one set of discrete data parameters).

The general point is that there may be a recognizable relationship between the set of parameters describing the location of links, and the content of the files associated with those links. In this context, it may be said that the files and/or content of files that are associated with links are embodied by, or related to, the set of discrete data parameters that identify the location of the links. This type of organization generally may provide organization of links and may facilitate retrieval of particular data files by a user.

In another example, absence of links associated with one or more sets of discrete data parameters may indicate that no data files are available. For example, absence of links to data files in the location described by “alcohol/drugs” (x-axis), “youth,” (y-axis), and “prevention” (z-axis) in FIG. 3 might indicate that the user is not in possession of information related to community health issues intersecting with alcohol/drugs, youth, and prevention. This may be useful, for example, in project planning, where efforts to obtain information related to certain areas are planned and executed. This type of analysis may be called “gap analysis.”

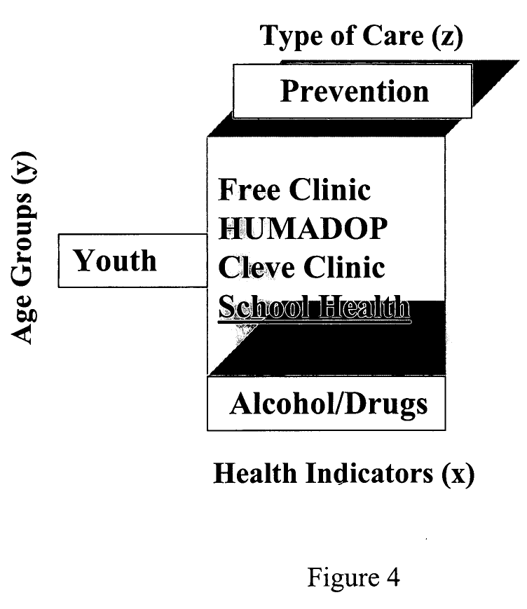

FIG. 4 illustrates another example visual representation of an organization of information. In this illustration, the single smaller cube whose location within the larger, multi-dimensional cube is described by the set of parameters, “alcohol/drugs” (x-axis), “youth,” (y-axis), and “prevention” (z-axis), is illustrated. This figure illustrates an organization of links to data files that is a subset of the links shown in FIG. 3. This figure also illustrates a subset of the 80 smaller cubes shown in FIG. 3.

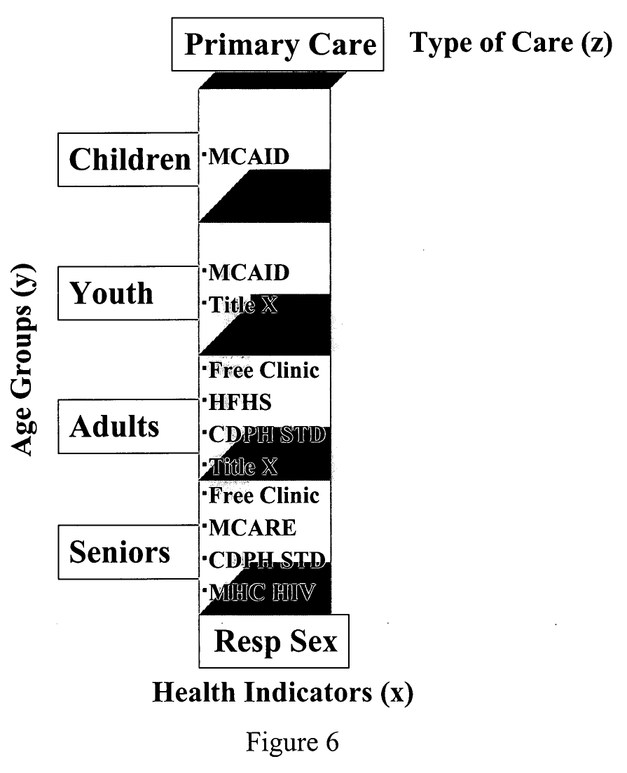

As will be discussed at more length in the descriptions of FIGS. 6 through 9 below, the system and methods disclosed herein are generally interactive to display an organization of information in a variety of ways. In one example, the systems and methods may be interactive to display subsets of links and objects based on categories and/or parameters specified by a user. In the particular example illustrated in FIG. 4, designation of “alcohol/drugs” (x-axis), “youth” (y-axis), and “prevention” (z-axis) may provide the display illustrated in FIG. 4. A user may be able to specify various categories and/or parameters by different methods. In one example, a user may “click” one or more locations within a top- or intermediate-level object to obtain the desired subset display. In another example, a user may enter particular parameters into the system to obtain the desired subset display. There may be other ways for a user to be interactive with, and navigate through, the system to obtain a desired display.

The links associated with the cube image shown in FIG. 4 are associated with the front face or front surface of the cube. In other examples, one or more links may be associated with different parts of a cube (e.g., sides, faces, surfaces, and so on) or whatever geometric shape is used for the image. One or more links may also be associated with the interior and/or exterior of the cube or other geometric shape. In another example, the system may have an interactive feature allowing the cube or other image to be rotated for the purpose of visualizing links associated with various surfaces of the geometric shape.

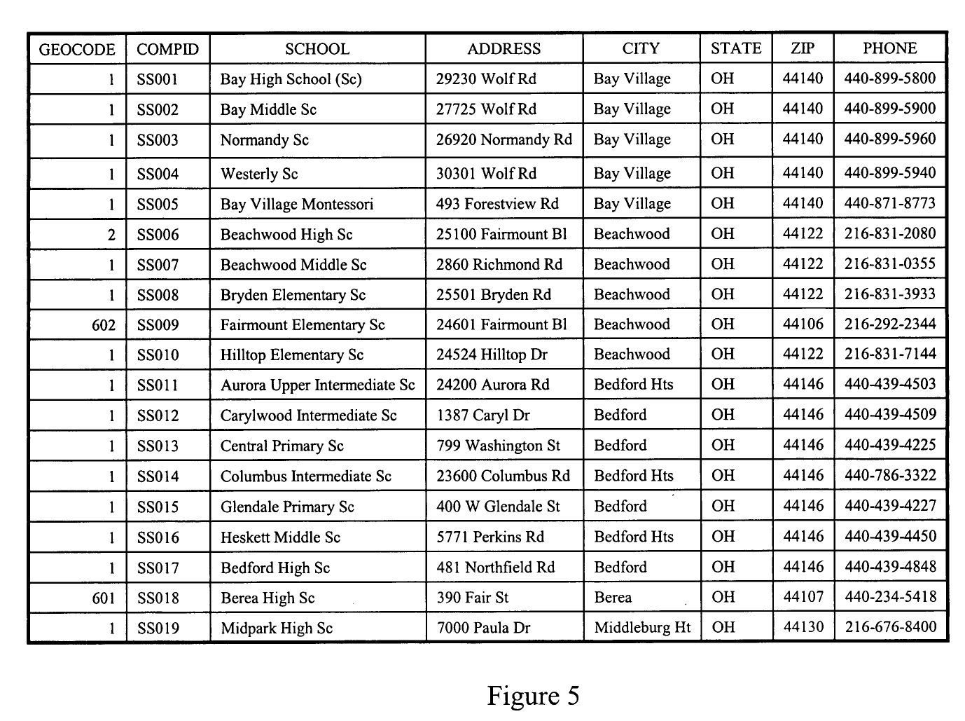

FIG. 5 illustrates content of an example data file. In one example, a user may view the contents of a data file by interacting with a link to the file. The contents of the file may be related to the x, y, z parameters of the image with which the data file is associated. This particular example data file is linked to the “School Health” link illustrated in FIG. 4. The contents of this particular data file lists schools in the Cleveland, Ohio area that may provide youth prevention programs for alcohol and/or drugs. In this example, the contents of the data file are embodied by the set of parameters (e.g., alcohol/drugs, youth, and prevention) describing the location of the link to the data file.

It will be appreciated that a variety of different types of data or files can be associated with or linked to an object or location in the visual representation. Although data files generally are linked to bottom-level images, in other examples, data files may be linked to one or more of top-level, intermediate-level, and bottom-level images. Data files may be of a type that include, but are not limited to, text files, image files, audio files, movie files, spreadsheets, databases, and so on. It may be possible to retrieve and/or display more than one data file or the contents of more than one file at one time.

FIGS. 6 through 9 illustrate example alternative organizations of information for the particular system shown in FIGS. 2 and 3. As stated earlier, in describing FIG. 4, these various example displays, as well as others, generally may illustrate subsets of links and objects based on categories and/or parameters specified or designated by a user. The various displays of links and objects generally reflect the interactive nature of the system and provide different views of data and links to data to a user.

FIG. 6 illustrates another example visual representation of an organization of information. In this particular example, specification or designation of the parameter “responsible sex” (x-axis or “health indicators” category), all parameters of the category “age groups” (y-axis), and the parameter “primary care” (z-axis or “type of care” category) may lead to this subset display. Groupings of links to related data files are illustrated within each pictured smaller cube.

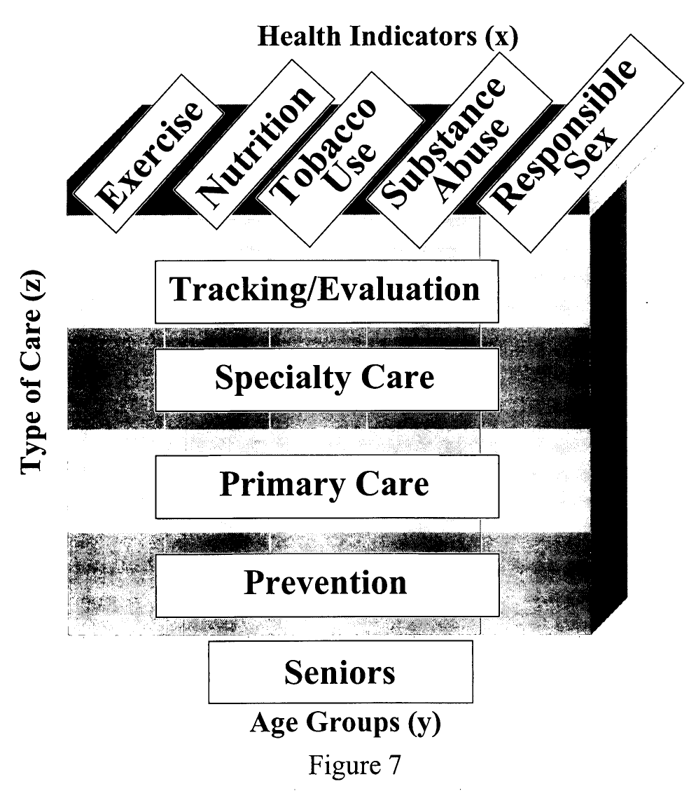

FIG. 7 illustrates another example visual representation of an organization of information. In this particular example, specification or designation of all parameters of the category “health indicators” (x-axis), the parameter “seniors” (y-axis or “age groups” category), and all parameters of the category “type of care” (z-axis) may lead to this subset display.

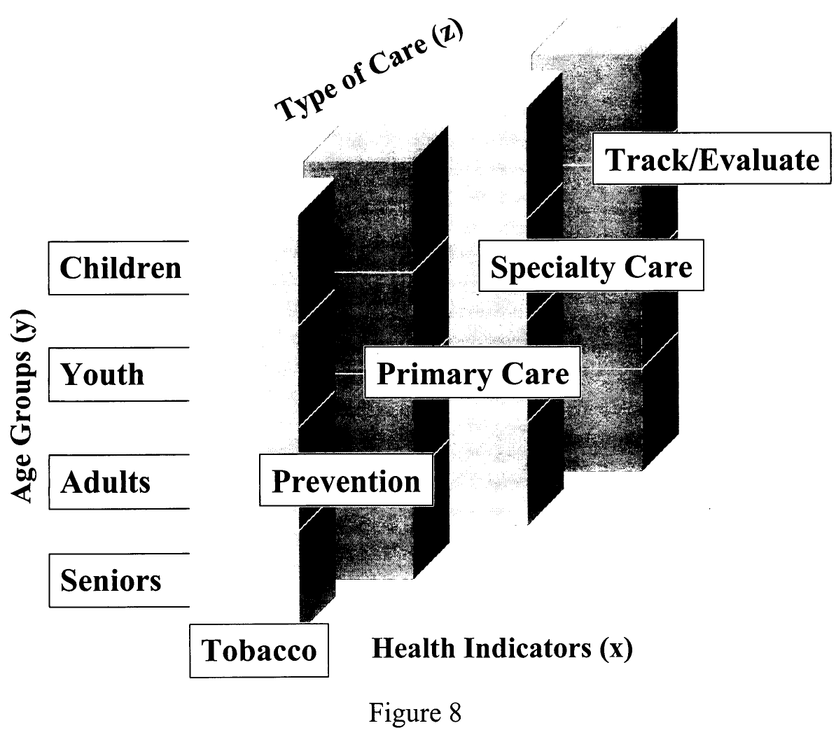

FIG. 8 illustrates another example visual representation of an organization of information. In this particular example, specification or designation of the parameter “tobacco” (x-axis or “health indicators” category), all parameters of the category “age groups” (y-axis), and all parameters of the category “type of care” (z-axis) may lead to this subset display.

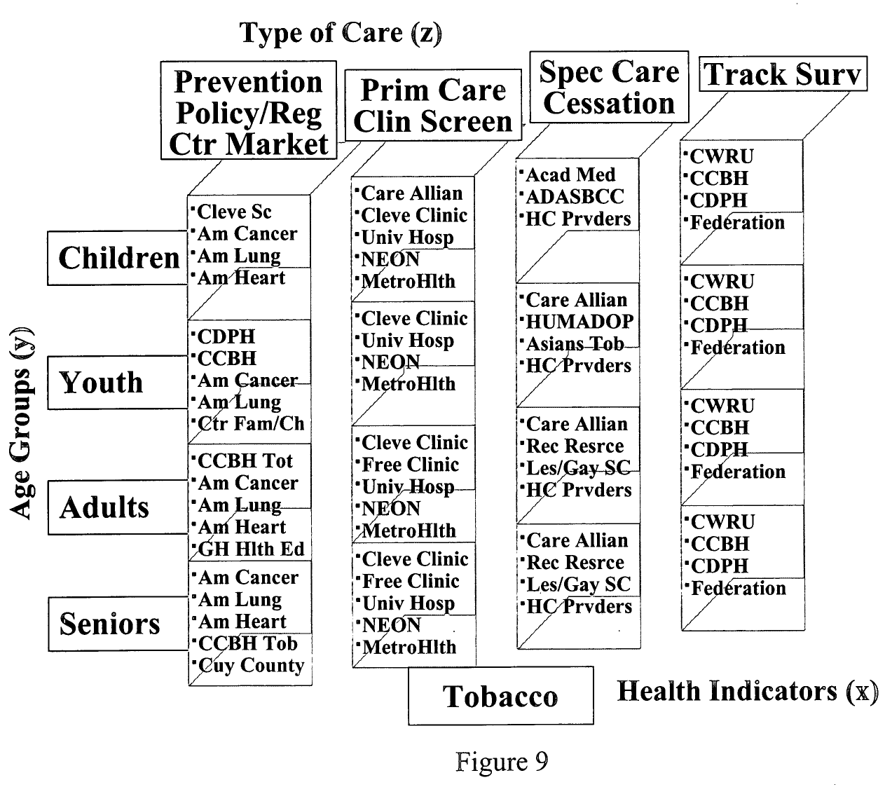

FIG. 9 illustrates another example visual representation of an organization of information. In this particular example, specification or designation of the parameter “tobacco” (x-axis or “health indicators” category), all parameters of the category “age groups” (y-axis), and all parameters of the category “type of care” (z-axis) may lead to this subset display. FIG. 9 also illustrates links to data files, organized into groups of links to related data files, that are illustrated within each pictured smaller cube. Note that, although the categories and parameters specified to obtain the displays in FIGS. 8 and 9 are the same, the displays themselves are different.

In addition to providing for organization and display of data, as described above, it will also be appreciated that the systems disclosed herein may provide an interface for entry of data. In one example, by clicking or otherwise designating an object, image, an axis of an image, a cube within an image, and so on, an area for entering data is provided. In one example, clicking or otherwise designating an image as above, may provide a call to an application program such as a word processing, spreadsheet, database, or other program. In these instances, the area for entering data may be a blank word processing, spreadsheet, database, or other file, associated with the application program. After data is entered into such a file, the file may remain associated with the image such that the data can be retrieved at a later time.

It will also be appreciated that the example systems for organizing and displaying data may contain or be associated with searching features. The searching features may be part of or related to the organization logic. In one type of search, for example, it may be possible to establish relationship data. In one type of search, it may be possible to search for a specified data file, type of data file, text within a data file, attribute of a data file, and so on. The results of the search may be visually represented in various ways. In one example, links to data files identified in a search may be visualized in a display that shows those links in the context of a bottom-level image. Other ways of displaying the results of a search within the context of a visual representation are possible.

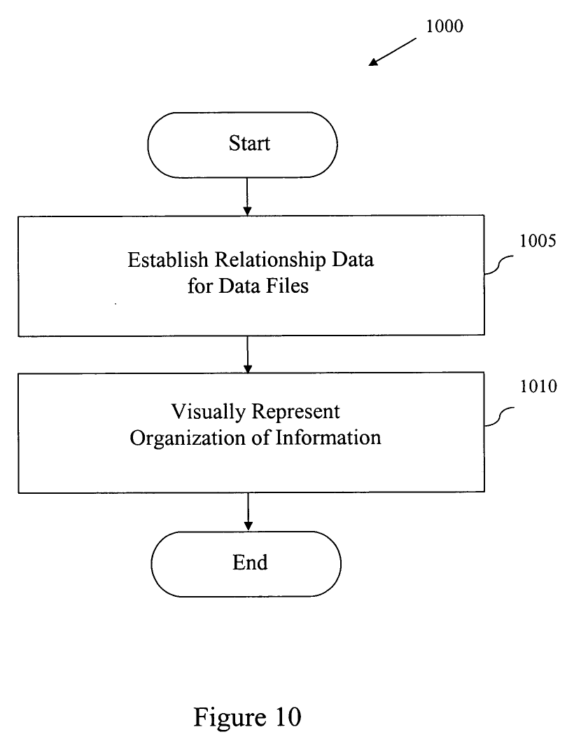

Example methods may be better appreciated with reference to the flow diagram of FIG. 10. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that various actions could occur concurrently, substantially in parallel, and/or at substantially different points in time.

Illustrated in FIG. 10 is an example methodology 1000, that can be associated with a system for organizing and/or displaying data. The illustrated elements denote “processing blocks” that may be implemented in logic. In one example, the processing blocks may represent executable instructions that cause a computer, processor, and/or logic device to respond, to perform an action(s), to change states, and/or to make decisions. Thus, the described methodologies can be implemented as processor executable instructions and/or operations provided by a computer-readable medium. In another example, the processing blocks may represent functions and/or actions performed by functionally equivalent circuits such as an analog circuit, a digital signal processor circuit, an application specific integrated circuit (ASIC), or other logic device. The diagram of FIG. 10 is not intended to limit the implementation of the described examples. Rather, the diagram illustrates functional information one skilled in the art could use to design/fabricate circuits, generate software, or use a combination of hardware and software to perform the illustrated processing.

It will be appreciated that electronic and software applications may involve dynamic and flexible processes such that the illustrated blocks can be performed in other sequences different than the one shown and/or blocks may be combined or separated into multiple components. Blocks may also be performed concurrently, substantially in parallel, and/or at substantially different points in time. They may also be implemented using various programming approaches such as machine language, procedural, object oriented and/or artificial intelligence techniques. The foregoing applies to all methodologies described herein.

FIG. 10 illustrates an example method 1000 for organizing and/or displaying data. The method 1000 may include establishing relationship data for multiple data files (block 1005). The method may also include visually representing an organization of data that concerns at least some of the multiple data files based, at least in part, on the relationship data (block 1010).

Establishing relationship data (block 1005) may include comparing one or more characteristics of data files to determine if the data files and/or their content are related, and/or the extent of the relatedness or relationship. Establishing relationship data (block 1005) may include examining data files, their content, their characteristics, and so on, and assigning and/or storing parameters that may define relatedness between the files.

Visually representing an organization of information (block 1010) may include grouping links to related data files proximate to one another within a visual display. Visually representing an organization of information (block 1010) may include defining the dimensions of a first image or object (e.g., top-level object) with data categories. The data categories may be delineated by discrete data parameters. The first image may be divided into smaller images or objects. The location of the smaller objects within the first, larger object, may be described by a “set” of discrete data parameters. A set of parameters may include a discrete data parameter from a data category defining each dimension of the first image or object. Links to data files may be associated with particular smaller objects and the location of particular smaller objects, as described by a set of discrete data parameters, may be descriptive or informative of the files associated with the links.

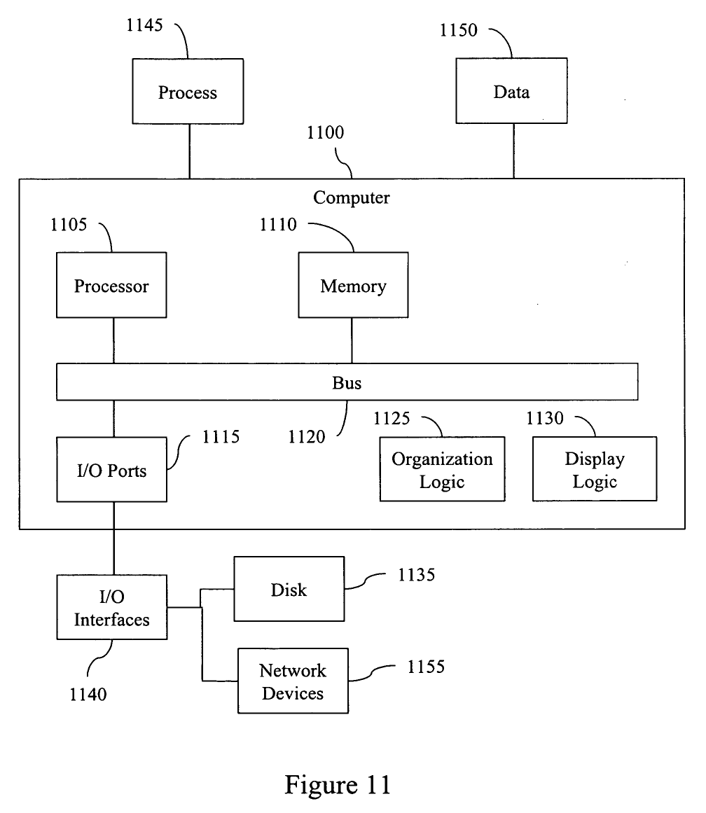

System 100 (FIG. 1) may be associated with and/or embedded in a variety of systems. One such system is a computer. FIG. 11 illustrates an example computer 1100 that includes a processor 1105, a memory 1110, and input/output ports 1115 operably connected by a bus 1120. Executable components of example systems described herein may be located on a computer like computer 1100. Similarly, example computer executable methods described herein may be performed on a computer like computer 1100. It is to be appreciated that other computers may also be employed with the example systems and methods described herein. The computer 1100 may include, for example, an organization logic 1125. The organization logic 1125 may be configured, for example, to establish relationship data for a plurality of data files. The computer 1100 may include, for example, a display logic 1130. The display logic 1130 may be configured, for example, to visually represent an organization of files and/or subject matter using the relationship data.

The processor 1105 can be a variety of various processors including dual microprocessor and other multi-processor architectures. The memory 1110 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and so on. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM).

A disk 1135 may be operably connected to the computer 1100 via, for example, an input/output interface 1140 and/or an input/output port 1115. The disk 1135 can include, but is not limited to, devices like a magnetic disk drive, a solid state disk drive, a floppy disk drive, a tape drive, a Zip drive, a flash memory card, and/or a memory stick. Furthermore, the disk 1135 can include optical drives like, a compact disc ROM (CD-ROM), a CD recordable drive (CD-R drive), a CD rewriteable drive (CD-RW drive) and/or a digital video ROM drive (DVD ROM). The memory 1110 can store processes 1145 and/or data 1150, for example. The disk 1135 and/or memory 1110 can store an operating system that controls and allocates resources of the computer 1100.

The bus 1120 can be a single internal bus interconnect architecture and/or other bus or mesh architectures. The bus 1120 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 1100 may interact with, for example, i/o interfaces 1140 via input/output ports 1115. Input/output interfaces 1140 can include, but are not limited to, a keyboard, a microphone, a pointing and selection device, cameras, video cards, displays, disk 1135, network devices 1155, and so on. The input/output ports 1115 can include but are not limited to, serial ports, parallel ports, and USB ports.

The computer 1100 can operate in a network environment and thus may be connected to network devices 1155 via the i/o interfaces 1140 and/or the i/o ports 1115. Through the network devices 1155, the computer 1100 may interact with a network. Through the network, the computer 1100 may be logically connected to remote computers and communicate with the remote computers. The networks with which the computer 1100 may interact include, but are not limited to, a local area network (LAN), a wide area network (WAN), and other networks. The network devices 1155 can connect to LAN technologies including, but not limited to, fiber distributed data interface (FDDI), copper distributed data interface (CDDI), Ethernet/IEEE 802.3, token ring/IEEE 802.5, wireless/IEEE 802.11, Bluetooth (IEEE 802.15.1 WPAN (wireless personal area network)), and so on. Similarly, the network devices 1155 can connect to WAN technologies including, but not limited to, point to point links, circuit switching networks like integrated services digital networks (ISDN), packet switching networks, and digital subscriber lines (DSL).

While example systems, methods, and so on, have been illustrated by describing examples, and while the examples have been described in considerable detail, it is not the intention of the applicant to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner. A Dictionary of Modern Legal Usage 624 (2d. Ed. 1995).

1. A system, comprising:
an organization logic configured to store relationship data for multiple data files; and
a display logic configured to visually represent an organization of information concerning at least some of the multiple data files based, at least in part, on the relationship data.

2. The system of claim 1, where the organization logic is configured to establish relationship data for the multiple data files.

3. The system of claim 2, where the system is embedded in a computer.

4. The system of claim 1, where the relationship data includes information concerning the relatedness of at least some of the multiple data files.

5. The system of claim 1, where the relationship data includes one or more of, related attributes, related content, related data parameters, related descriptions, and related locations of at least some of the multiple data files.

6. The system of claim 1, where the organization of information includes links that are associated with at least some of the multiple data files.

7. The system of claim 6, where the links are organized into groups based, at least in part, on relatedness of the data files associated with the links.

8. The system of claim 6, where the links enable retrieval of the associated data files.

9. The system of claim 8, where the retrieval of at least some of the data files is optimized by the organization of information.

10. The system of claim 1, where the visually represented organization of information is configured to be interactive.

11. An organization of links to data files, comprising:
a visual representation of at least one multi-dimensional object, where separate dimensions of the object are labeled as data categories, the data categories delineated by discrete data parameters; and
at least one proximal grouping of links to related data files, the proximal grouping of links occupying a set of discrete data parameters within the multi-dimensional object.

12. The organization of links to data files of claim 11, where a set of discrete data parameters includes a discrete data parameter from a data category that labels each dimension of the multi-dimensional object.

13. The organization of links to data files of claim 11, where the multi-dimensional object includes smaller objects that occupy the sets of discrete data parameters within the multi-dimensional object.

14. The organization of links to data files of claim 13, where the smaller objects include surfaces and where links of a proximal grouping are associated with the surfaces of a smaller object.

15. The organization of links to data files of claim 13, where the organization of links to data files is interactive to display a subset of the smaller objects based, at least in part, on one or more specified discrete data parameters.

16. The organization of links to data files of claim 11, where the organization of links to data files is interactive to display a subset of the proximal groupings of links based, at least in part, on one or more specified discrete data parameters.

17. The organization of links to data files of claim 11, where the relatedness of the data files whose links are included in a proximal grouping of links is embodied, at least in part, by the set of discrete data parameters occupied by the proximal grouping of links.

18. A method, comprising:
establishing relationship data for multiple data files; and
visually representing an organization of information concerning at least some of the multiple data files based, at least in part, on the relationship data.

19. The method of claim 18, where establishing relationship data includes comparing at least one characteristic of a first data file with at least one characteristic of a second data file to establish relatedness between the first and second data files.

20. The method of claim 18, where establishing relationship data includes assigning data parameters to at least some of the multiple data files.

21. The method of claim 18, where visually representing an organization of information includes grouping links to related data files proximate to one another within a visual display.

22. The method of claim 18, where visually representing an organization of information includes:
defining the dimensions of a first image with data categories, the data categories delineated by discrete data parameters;
dividing the first image into a plurality of second images, the location of each of the second images within the first image described by a set of discrete data parameters including a discrete data parameter from each data category; and
displaying links to related data files in association with a particular second image, the set of discrete data parameters embodying at least part of the content of the related data files.

23. A computer-readable medium for providing processor executable instructions operable to perform a method, the method comprising:
establishing relationship data for multiple data files; and
visually representing an organization of information concerning at least some of the multiple data files based, at least in part, on the relationship data.

24. A system, comprising:
means for establishing relationship data for multiple data files; and
means for visually representing an organization of information concerning at least some of the multiple data files based, at least in part, on the relationship data.
